(19) United States
(12) Patent Application Publication
(10) Pub. No.: US 2008/0179263 A1
(43) Pub. Date: Jul. 31, 2008

(54) COMBINED FILTER APPARATUS, SYSTEM, AND METHOD

(76) Inventors: Mark T. Wieczorek, Cookeville, TN (US); Naren Shaam, Cookeville, TN (US); Charles W. Hawkins, Sparta, TN (US); Chad M. Thomas, Algood, TN (US); Ted Loftis, Cookeville, TN (US); Barry M. Verdegan, Stoughton, WI (US); Zemin Jiang, Cookeville, TN (US)

Correspondence Address: Kunzler & McKenzie, 8 EAST BROADWAY, SUITE 600, SALT LAKE CITY, UT, 84111, US

(21) Appl. No.: 11/831,911

(22) Filed: Jul. 31, 2007

Related U.S. Application Data
(60) Provisional application No. 60/820,929, filed on Jul. 31, 2006.

(51) Int. Cl. B01D 27/14; B01D 27/08

(52) U.S. Cl. 210/806; 210/323.1; 210/346; 210/295; 210/314

(57) ABSTRACT

A combined filter apparatus includes a first filter element, a second filter element disposed in stacking arrangement to the first filter element, a housing enclosing the filter elements, a seal sealing the dirty side of the first filter element from the dirty side of the second filter element, a first inlet disposed in the housing for fluid flow to the first filter element, a second inlet disposed in the housing for fluid flow to the second filter element, and an outlet disposed in the housing for fluid flow from at least one of the filter elements.

### PRIORITY APPLICATIONS

This application claims priority benefit of U.S. Provisional Patent Application No. 60/820,929, filed 31 Jul. 2006, titled “Combined Filter Apparatus, System, and Method,” which is incorporated herein by reference in its entirety.

### BACKGROUND OF THE INVENTION

1. Field of the Invention

This invention relates to filters and filtration, and more particularly to filtration systems requiring multiple filters.

2. Description of the Related Art

It is inconvenient for engine and equipment operators to have to service multiple filters. The fuel, lube, air, crankcase ventilation, coolant and/or other filters must be replaced and not always at the same time, due to different service intervals for different fluids. In addition to the inconvenience, there is also the risk of not servicing a filter soon enough and damaging the system. The filter may also be serviced too soon, thus increasing operating costs. Finally, there is a problem that the wrong filter, such as one that physically fits but is the wrong efficiency or flow rating, may be installed.

From the foregoing discussion, it should be apparent that a need exists for a filter apparatus, system, and method that addresses the shortcomings of the prior art.

### BRIEF DESCRIPTION OF THE DRAWINGS

In order that the advantages of the invention will be readily understood, a more particular description of the invention will be rendered by reference to specific embodiments illustrated in the appended drawings, which depict only typical embodiments of the invention and are not to be considered limiting of its scope, in which:

FIG. 1 is a schematic depiction of an embodiment of a combined filter apparatus according to the present invention;

FIG. 2 is a schematic depiction of a combined filter element used in the apparatus of FIG. 1;

FIG. 3 is a view along line 3-3 of FIG. 1;

FIG. 4 is a cross-sectional view of an embodiment of a combined filter apparatus according to the present invention;

FIG. 5 is an exploded perspective view of the combined filter element used in the apparatus of FIG. 4;

FIG. 6 is a perspective view of the top filter element assembly used in the apparatus of FIG. 4;

FIG. 7 is a perspective view of the bottom filter element assembly used in the apparatus of FIG. 4;

FIG. 8 is an inverted perspective view of the top filter element assembly and center tube of the apparatus of FIG. 4;

FIG. 9 is a sectional view of the joining of the top and bottom filter element assemblies of the apparatus of FIG. 4;

FIG. 10 is an inverted cross-sectional view of the combined filter element of FIG. 5;

FIG. 11 is a schematic illustration of an embodiment of a combined filtering method according to the invention;

FIG. 12 is a schematic illustration of another embodiment of a combined filtering method according to the invention.

### SUMMARY OF THE INVENTION

The present invention has been developed in response to the present state of the art, and in particular, in response to the problems and needs in the art that have not yet been fully solved by currently available filter systems. Accordingly, the present invention has been developed to provide an apparatus, system, and method for combined filtering that overcome many or all shortcomings in the art.

In one aspect of the invention, a combined filter apparatus includes a plurality of filter elements disposed integrally with each other, and a seal sealing at least a portion of the filter elements from each other.

In a further aspect of the invention, a combined filter apparatus includes a first filter element having a dirty side, a clean side, and an end, a second filter element having a dirty side, a clean side, and an end, the second element's end abutting the first element's end, and a seal sealing the dirty side of the first filter element from the dirty side of the second filter element.

In a further aspect of the invention, a method of filtering fluid includes urging a first fluid through a first inlet and first filter element, and urging a second fluid through a second inlet and second filter element abutting and sealed from the first filter element.

In a further aspect of the invention, a method for servicing a combined fluid filter includes providing a housing, providing a combined fluid filter element, the element comprising a first portion and a second portion, placing the combined fluid filter element into the housing, and sealing fluid flow to the first portion from fluid flow to the second portion.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages of the present invention will become more fully apparent from the following description and appended claims, or may be learned by the practice of the invention as set forth hereinafter.

### DETAILED DESCRIPTION OF THE INVENTION

Reference throughout this specification to “one embodiment, ” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention allows multiple filters to be replaced by a single filter, enables multiple filters to be serviced at the same time in a single operation, simplifies service, helps ensure that the proper filters are used, and decreases the chances that an operator may forget to service a filter, resulting in the filter going too long between service intervals.

One embodiment of the present invention comprises a combination filter element, particularly suited for module applications, comprising two or more filter element subassemblies, in which each element subassembly filters either a different fluid or the same fluid in series. In one embodiment, a single replaceable filter element comprises two or more filter subassemblies such that all may be replaced simultaneously.

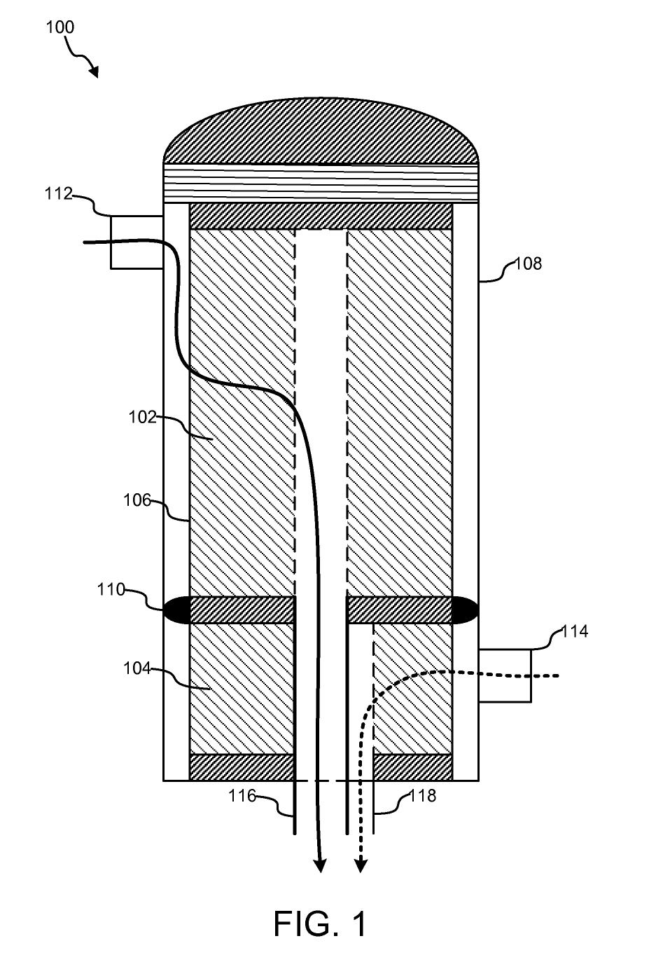

FIG. 1 schematically illustrates an embodiment of the invention comprising a combined filter 100 in which two filter subassemblies 102 and 104—which may be, e.g., fuel and lube filters, primary and secondary fuel filters, air and crankcase ventilation filters—are combined in a single element 106 and housing 108. Depending on customer requirements, two, three or more assemblies could be incorporated into a single element.

As shown, the combination may comprise individual filter subassemblies 102 and 104 stacked atop one another with appropriate seals 110 between subassemblies to prevent mixing of fluids. Other embodiments may include the subassemblies being positioned side by side or nested one inside the other. Each subassembly 102 and 104 is sized appropriately so that all elements will have the appropriate flow rating, pressure drop, and life, corresponding to customer requirements and the service interval. In order to accomplish this, the subassemblies 102 and 104 may differ in terms of their height, diameter, pleat density and filter media. The subassemblies 102 and 104 will generally be pleated filter elements, though other embodiments are within the scope of the invention, including subassemblies of stacked cellulose discs (as used in bypass lube filters), unpleated nonwoven depth media (as used in crankcase ventilation coalescers), an impactor unit (as used in crankcase ventilation), or a centrifuge (as used in bypass lube filtration). The housing 108 holding the elements contains separate inlets 112 and 114 and outlets 116 and 118 for each fluid. The housing 108 may be a canister or part of a module system, along with associated valving, sensors and other components.

A combined filter according to the invention may comprise separate subassemblies for two or more combinations of fluids—fuel, lube, coolant, air, crankcase, hydraulic, transmission, etc.—or for primary and secondary filter subassemblies (as well as tertiary, etc., as needed) for the same fluid.

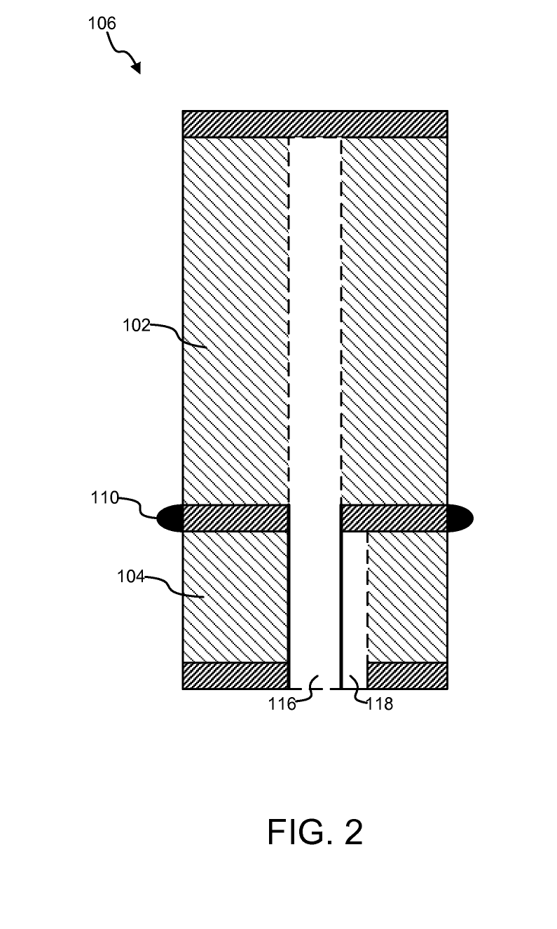

FIG. 2 schematically illustrates the combination element 106. As noted above, the combination element 106 comprises the subassemblies 102 and 104, which are joined to form one filter element 106. Each subassembly 102 and 104 comprises all the individual components necessary for a full element assembly for the particular fluid or application, as will be apparent to those skilled in the art in light of this disclosure, but the subassemblies are operationally joined to form a single combined element 106 that can be removed and replaced as an integral unit. In one embodiment, separate flow paths through at least part of the element are required to prevent mixing and contamination of fluids. In the combined filter 100, the flow paths for the fluid flowing through the subassembly 102 and the fluid flowing through the subassembly 104 are completely isolated.

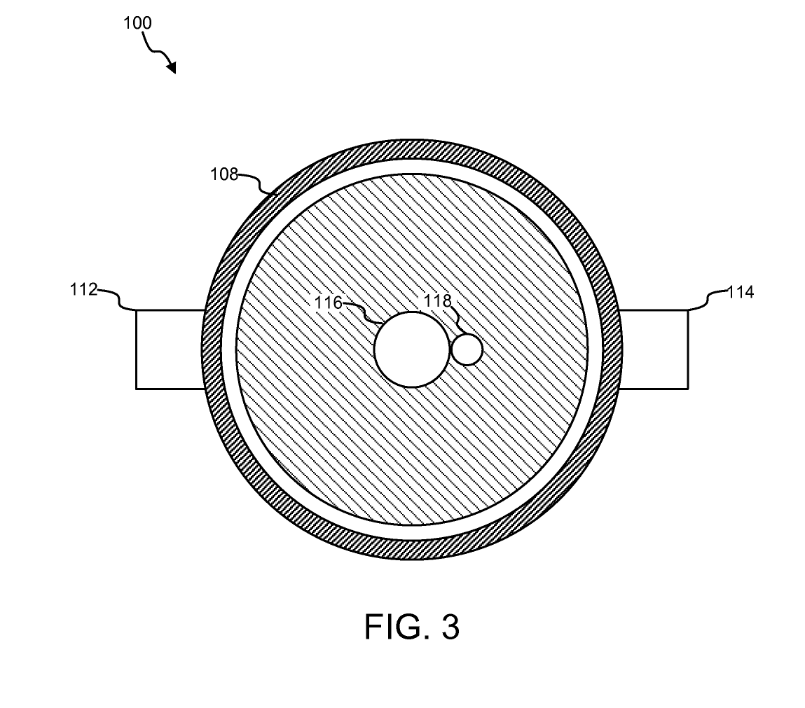

FIG. 3 is a cross-sectional view of the combined filter 100, showing how the two fluid flow paths are isolated. Referring also to FIGS. 1 and 2, the outlet tube 116 of the first subassembly 102 is disposed in the radial center of the filter 100, with the outlet tube 118 of the second subassembly 104 disposed adjacent but separate from the outlet 102. Both outlets 116 and 118 direct the fluid from the filter 100 at the bottom of the combined element 106. In one embodiment, the bottom of the combined element 106, together with the two fluid outlet tubes 116 and 118, mates to fluid outlet ports (not shown) at a nonsymmetrical, keyed interface. This is an advantage in that only filter elements with identical keyed features will install properly into the housing 108, preventing inadvertent use of the wrong filter element. Other embodiments are possible with nested outlets, or outlets emerging at different locations of the housing 108.

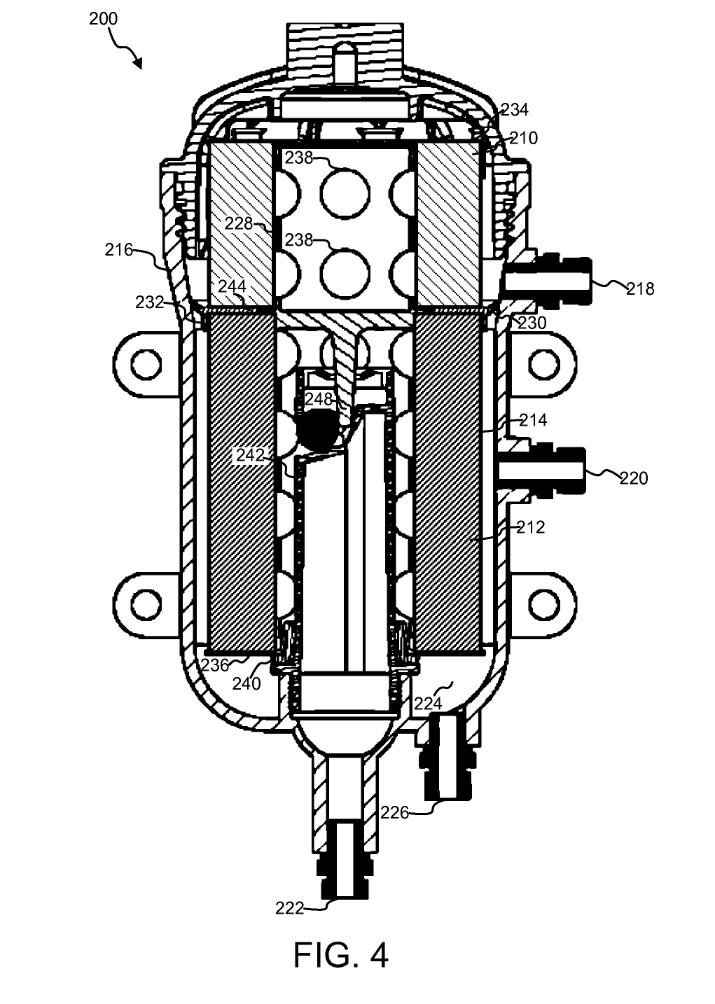

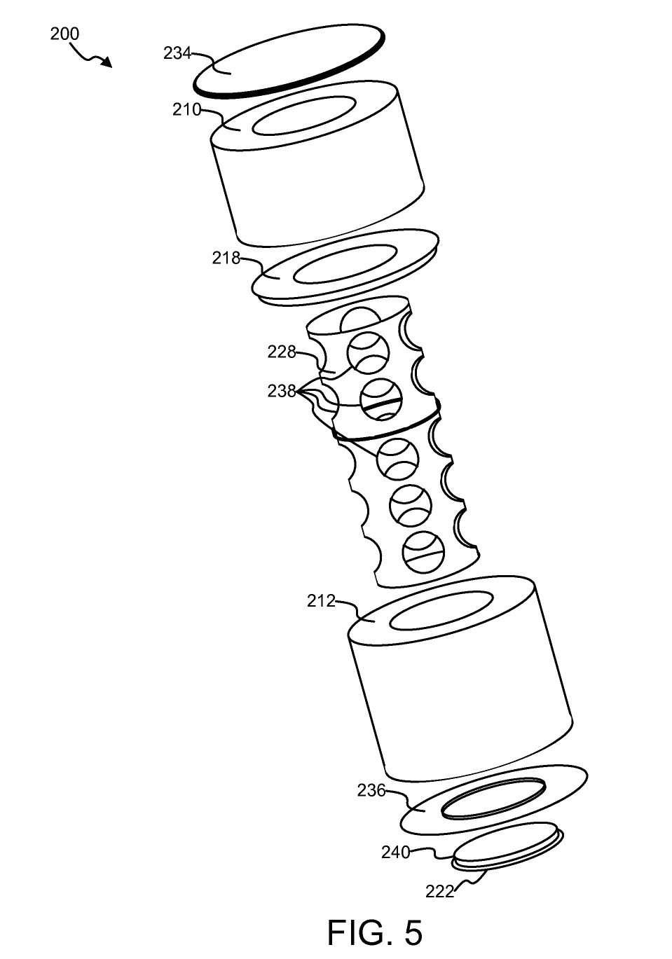

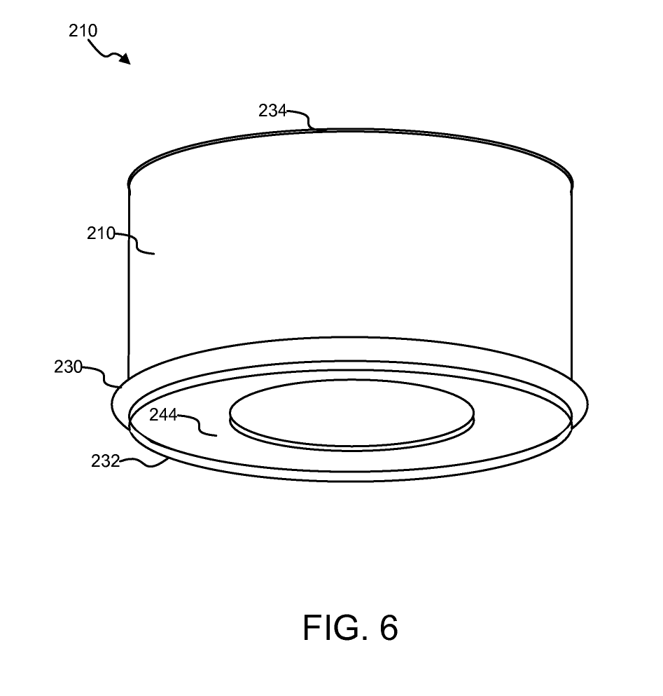

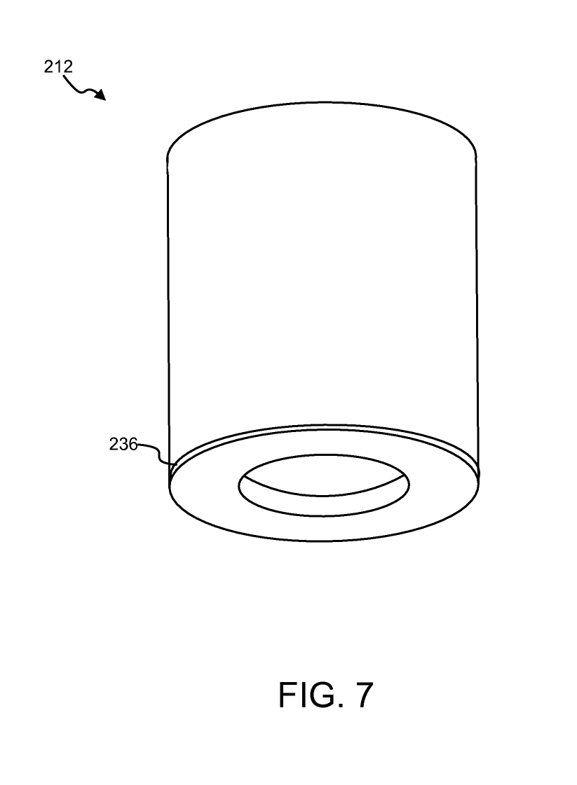

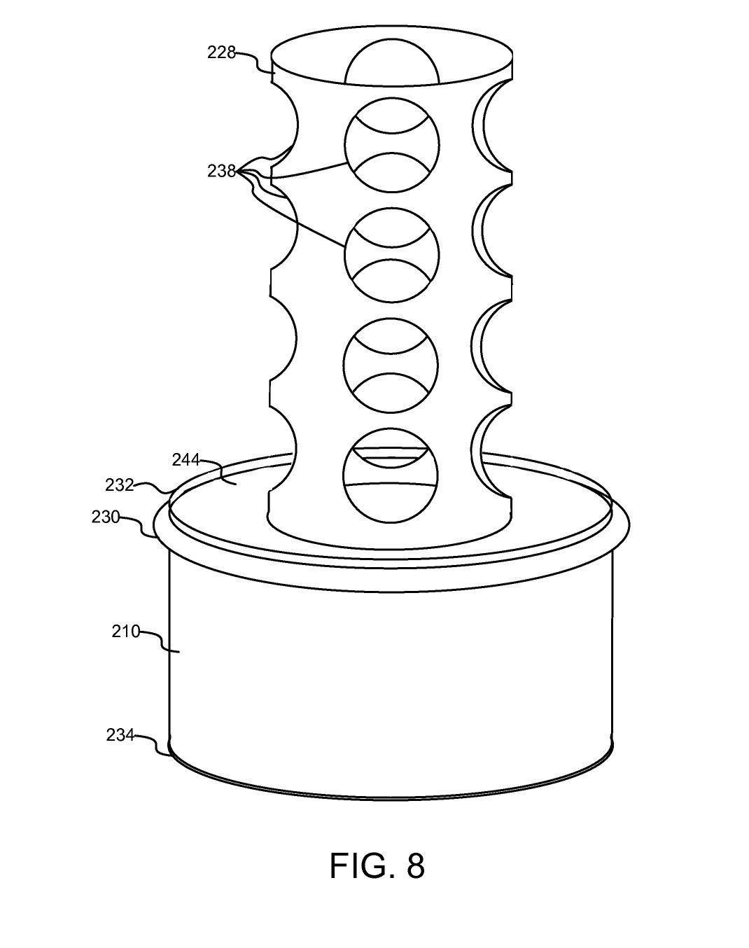

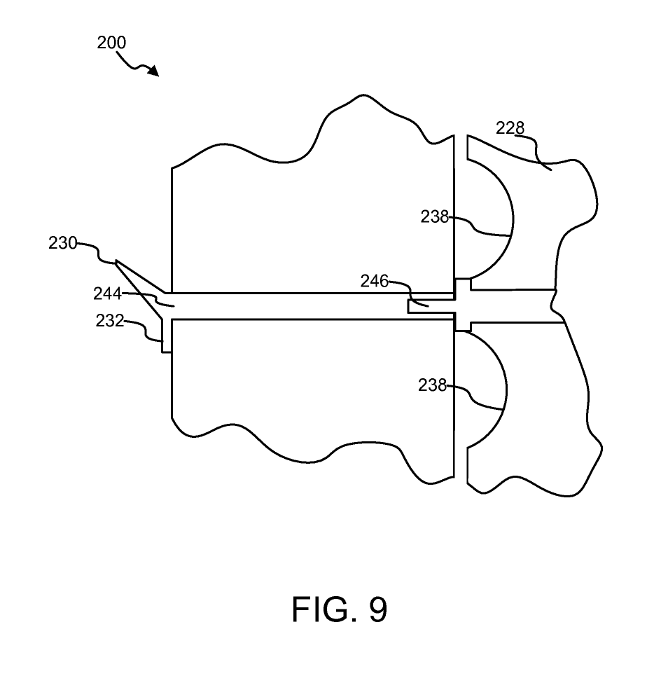

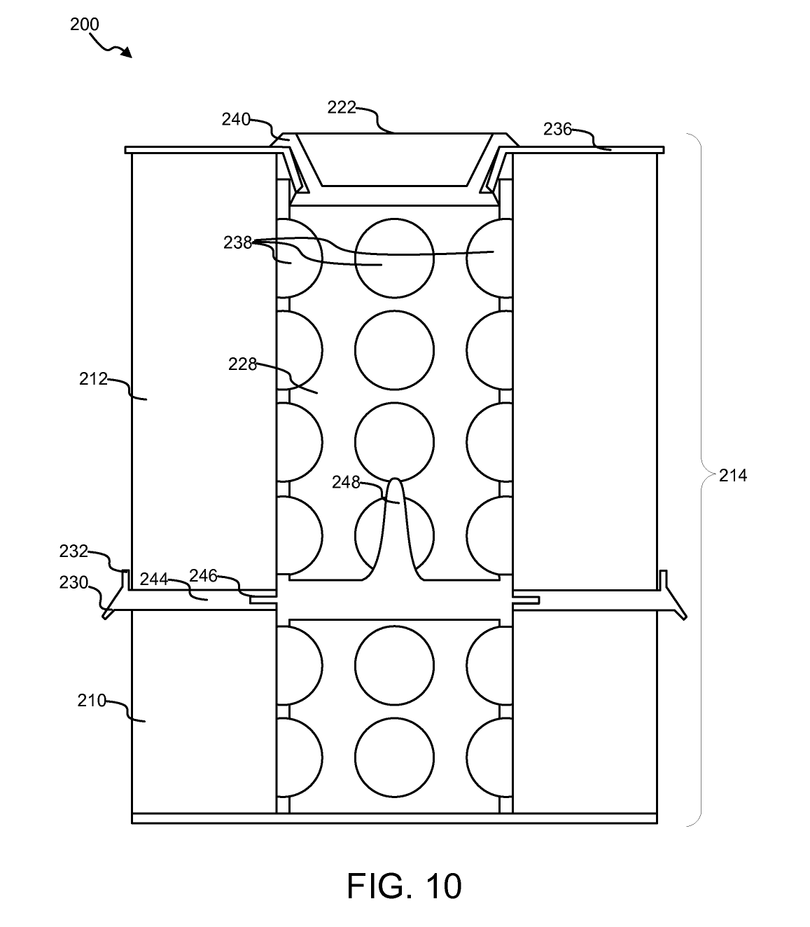

Referring now to FIGS. 4-10, an embodiment of a combined filter 200 according to the present invention is shown, which comprises a system for unifying two independent filter elements 210 and 212 into a single serviceable part. This is useful, among other situations, when separate filters are needed in a fluid system and where the filtered outlets of the filters are later combined into one fluid stream.

The unified filter cartridge 214 is inserted into a single cavity in the filter housing 216, with the two media packs or elements 210 and 212 fluidly separated on the dirty side by a seal 230. As noted above, it is envisioned that more than two media packs or elements could be combined into a single filter in a similar manner, limited by the practicality of size.

The two independent filter elements 210 and 212 can be sized to achieve an optimum balance of media area for the separate fluid streams. In prior art apparatuses, both streams would be combined prior to entering the filter, thus requiring the media area to be sized for the total combined flow. By separating the media packs, an optimum media material and area may be chosen for each separate fluid stream, each stream entering one of the media packs or elements 210 and 212. The result may include reduced total space or filter volume, reduced component part count, reduced media cost (e.g., high tech media only used where needed), and lower total filter cost when compared with two separate filters or a single large filter. Also, by combining the two filter elements 210 and 212 into a single filter cartridge 214, the end user will have a simplified filter service, having to purchase and replace only one part.

An example of a fluid system which could benefit from the present invention is a standard fuel system where in prior art devices the fuel first goes through a first filter where water separation and partial filtration occur. The flow then goes to a fuel injection system. The injector pilot valve return fuel flow (and other return flow) is then filtered by a second filter, which serves as a recirculation filter, performing only particle filtration (water separation is not needed). The filtered flow from the first and second filters are then recombined into a single flow stream, again heading to the injection system.

According to the present invention, the first and second filters can be replaced by the filter elements 210 and 212 in the embodiment illustrated by the filter 200, which filter elements have separate inlets 218 and 220, respectively, but (in contrast to the combined filter 100 described above) have a common outlet 222. (The filter 200 also has a water sump 224 and drain 226, for collection and drainage of water.) The elements 210 and 212 are supported by a center tube 228. The seal 230 extends from between the elements 210 and 212 and abuts the housing 216 to seal the filter elements 210 and 212 from each other on the dirty side.

The filter 200 also includes a top endplate 234, which is disposed on the top end of the filter element 210, an endplate 244 disposed between the filter elements 210 and 212, and a bottom endplate 236, which is disposed on the bottom end of the filter element 212. The filters and endplates are configured such that they collectively constitute the combined filter element 214. A collar 232 extends downwardly from the endplate 244 to engage the filter element 212 in sealing engagement. The seal 230 extends radially, like a flange, from the endplate 244.

The center tube 228 is constructed of sufficient length, thickness, and material to support both media packs or elements 210 and 212. The center tube 228 contains holes 238 for the passage of fluid into the outlet 222.

A gasket 240 is disposed on the bottom endplate 236 to seal the bottom endplate 236's clean fuel passage to a standpipe 242 in the filter housing 216.

In one embodiment of a method of constructing the filter 200, the top endplate 234 and endplate 244 are assembled to the media pack or element 210 through embedding or other method known in the art, creating a first media pack assembly. The bottom endplate 236 is assembled to the media pack or element 212, through embedding or other method, creating a second media pack assembly. The first media pack assembly is placed upside down on the work surface, and the center tube 228 is inserted, coming to rest on the surface of the top endplate 234.

In one embodiment, an interlocking mechanism 246 between the center tube 228 and the endplate 244 may be utilized to hold the parts in position and close the joint between the endplate 244 and center tube 228. In an alternative embodiment, the endplate 244 has a lip formed at its internal diameter to prevent migration of any adhesive. If the interlocking mechanism 246 is used, the internal diameter of the media packs 210 and 212 can be in closer proximity to the center tube 228, providing less space between them, which provides better support for the media pleats of the elements 210 and 212, since the pleats flex less before contacting the supporting center tube 228. In one embodiment, a gap of 0-2 millimeters between the elements 210 and 212 and the center tube 228 may be provided. A 1-millimeter nominal annular gap will allow easy installation of the center tube 228 and good support for the media 210 and 212.

In some cases, the center tube 228 can be eliminated altogether, such as in low delta or differential pressure applications and coreless filter configurations, where the permanent standpipe 242 in the filter housing 216 directly supports the media.

In one embodiment of a method of constructing the combined filter element 216, the bottom of the endplate 244 is filled with epoxy or other appropriate adhesive, and the second media pack assembly is installed over the center tube 228 and down onto the epoxy-filled endplate 244. The epoxy/adhesive is cured in the appropriate method, and the bottom endplate 236 and gasket 240 are installed.

When the combined filter element 214 is installed in a filter housing 216, the seal 230 located on the endplate 244 will seal to the internal diameter of the filter housing 216, creating a separate fluid space for the dirty side of the upper media pack 210 and the dirty side of the lower media pack 212. This seal may be created in many forms, to include a flange 230 molded directly to and of the same material as the endplate 244, as shown, or by the addition of a separate sealing element such as a elastomeric gasket, O-ring, co-molded or insert-molded gasket, non-woven material seal, protrusion of layers of media, and other methods that will be apparent to those skilled in the art in light of this disclosure. When molded as an integral part of the endplate 244, the flexible, thin protrusion 230 can extend in the upward or downward direction, and can consist of a single or multiple flanges.

In one embodiment, a pin 248 disposed within the inner diameter of the center tube 228 actuates a no-filter, no-run feature. When the elements 210 and 212, with accompanying components, are properly installed to create the single combined element 214, the pin 248 interacts with the permanent standpipe 242 to allow flow of the fluid, as will be apparent to those skilled in the art in light of this disclosure. If the combined element 214 (including the pin 248) is missing from the housing 216, fluid flow is not allowed through the housing 216.

The pin 248 may be located between the filter elements 210 and 212, as shown, or at any point along the axis of the center tube 228 to position it at the ideal height for the particular filter system. In one embodiment, the pin 248 is positioned at a height above the level of the fuel when the filter cartridge is removed). An alternative location for the pin is on the interior (bottom) side of the top endplate 234 or other position.

The bottom endplate 236 may comprise an oval seal in one embodiment. The components of the filter 200 may also be snapped or spin-welded together. The combined filter 200 may be used in a modular or remote-mounted filter system.

In the schematic flow chart diagrams that follow, the depicted order and labeled steps are indicative of embodiments of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

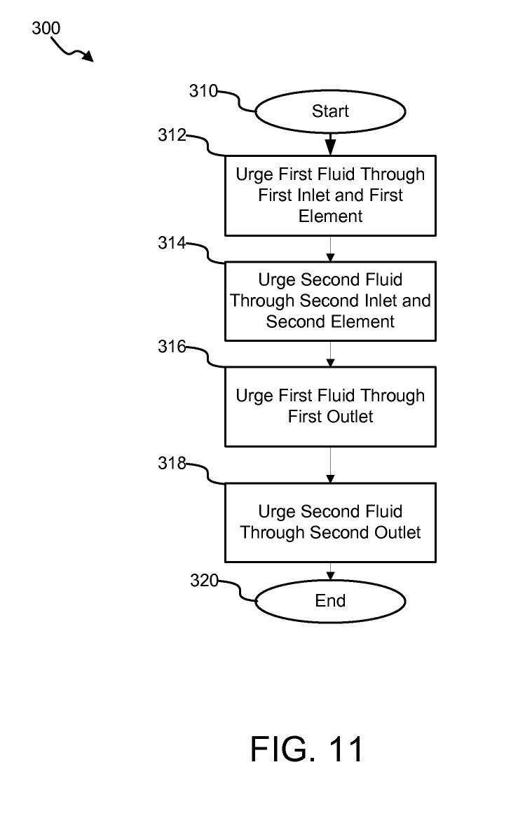

Referring to FIG. 11, one embodiment 300 of a method for urging a fluid through the inventive apparatus is described. The method starts with a block 310, and in block 312 a first fluid is urged through a first inlet and first portion of a filter element, such gas the top element portion described in FIGS. 1 and 2. In block 314, a second fluid is urged through a second inlet and second portion of the element, such as the lower element portion described in relation to FIGS. 1 and 2. In block 316 the first fluid is urged through a first outlet, such as the outlet 116, and in block 318 a second fluid is urged through a second outlet, such as the outlet 118. The method ends in block 320.

As can be seen from the description of the method 300, the differing filter elements, such as filter elements 102 and 104 in FIGS. 1 and 2, can be described as first and second portions of a single filter element with a seal between them.

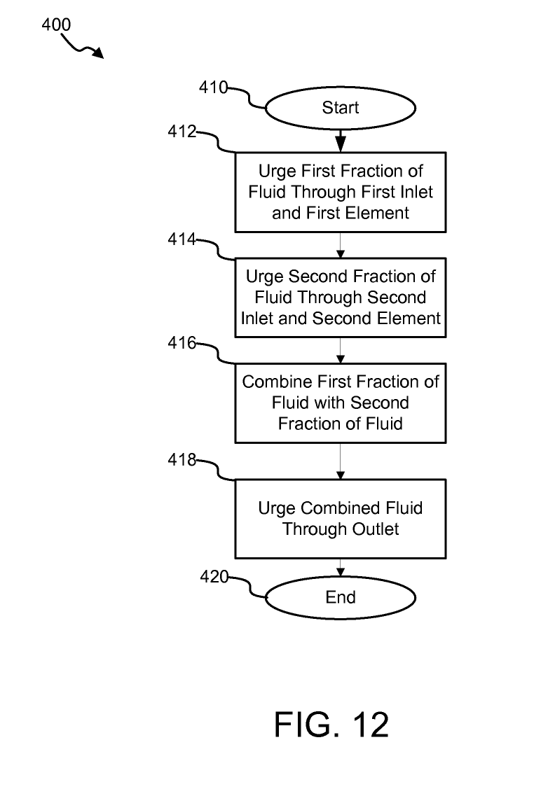

Referring now to FIG. 12, an embodiment of a method 400 of filtering a single fluid through two different filter elements or element portions is described. The method 400 begins in block 410. In block 412 a first fluid fraction is urged through a first inlet and portion of the element. The first inlet may be an inlet such as inlet 218 (FIG. 4), and the first element portion may be sub-element 210. In block 414, a second fluid fraction is urged through a second inlet and second portion of the element, such as inlet 220 and sub-element 212 in FIG. 4. In block 416, the fluid fractions are combined in, for example, the center post 228 and standing pipe 242. In block 418, the combined fluid is urged through an outlet such as the outlet 222.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A combined filter apparatus, the apparatus comprising:
a plurality of filter elements disposed integrally with each other;
a seal sealing at least a portion of the filter elements from each other.

2. The apparatus of claim 1, wherein the seal seals the filter elements entirely from each other.

3. A combined filter apparatus, the apparatus comprising:
a first filter element having a dirty side, a clean side, and an end;
a second filter element having a dirty side, a clean side, and an end, the second element's end abutting the first element's end;
a seal sealing the dirty side of the first filter element from the dirty side of the second filter element.

4. The apparatus of claim 3, further comprising a housing enclosing the filter elements, a first inlet disposed in the housing for fluid flow to the first filter element, a second inlet disposed in the housing for fluid flow to the second filter element, and an outlet disposed in the housing for fluid flow from at least one of the filter elements.

5. The apparatus of claim 4, further comprising an endplate disposed between the filter elements, and wherein the seal comprises a flange extending from the endplate to the housing.

6. The apparatus of claim 4, wherein the outlet is configured to receive fluid flow solely from the first filter element, and further comprising a second outlet configured to receive fluid flow solely from the second filter element.

7. The apparatus of claim 4, wherein the outlet is configured to receive fluid flow from the first and second filter elements.

8. The apparatus of claim 7, wherein the fluid is fuel, the first filter element is configured to separate water from the fuel, and the second filter element is configured to separate particulate matter from the fuel.

9. The apparatus of claim 4, wherein the first and second filter elements comprise first and second portions, respectively, of a single filter element.

10. A method of filtering fluid, the method comprising:
urging a first fluid through a first inlet and first filter element;
urging a second fluid through a second inlet and second filter element abutting and sealed from the first filter element.

11. The method of claim 10, further comprising urging the first fluid through a first outlet and the second fluid through a second outlet.

12. The method of claim 10, further comprising urging the first fluid and the second fluid through a common outlet.

13. A filtering system, the system comprising:
a housing;
a first substantially annular filter element, having a first interior volume, the first filter element disposed within the housing, with a first space disposed between the outer surface of the first filter element and the housing;
a second substantially annular filter element, having a second interior volume, the second filter element disposed within the housing and abutting the first filter element such that the first and second filter elements collectively form a single substantially annular shape having a collective interior volume, with a second space disposed between the outer surface of the first filter element and the housing;
a plate disposed at the junction of the first and second filter elements and substantially radially co-extensive therewith;
a seal disposed at the outer edge of the plate, the seal extending from the outer edge of the plate to the housing, preventing fluid communication between the first and second spaces;
a first inlet disposed in the housing adjacent the first filter element such that the first inlet is in fluid communication with the first space;
a second inlet disposed in the housing adjacent the second filter element such that the second inlet is in fluid communication with the first space;
at least one outlet disposed in the housing.

14. The system of claim 13, wherein the outlet is in fluid communication solely with the first interior volume, and further comprising a second outlet, the second outlet being in fluid communication solely with the second interior volume.

15. The system of claim 13, wherein the outlet is in fluid communication with the collective interior volume.

16. The system of claim 13, further comprising a center post disposed within the collective interior volume.

17. The system of claim 16, further comprising an interlocking mechanism locking the center post to the plate.

18. The system of claim 16, further comprising a second plate disposed at the axial end of the first filter element opposite the first plate, and a third plate disposed at the axial end of the second filter element opposite the first plate.

19. A combined fluid filter apparatus comprising:
means for filtering a first fluid within a housing;
means for filtering a second fluid simultaneously with, separate from, and adjacent to the first fluid within the housing.

20. A method for servicing a combined fluid filter, comprising:
providing a housing;
providing a combined fluid filter element, the element comprising a first portion and a second portion;
placing the combined fluid filter element into the housing; sealing fluid flow to the first portion from fluid flow to the second portion.
